(19) United States
(12) Patent Application Publication
(10) Pub. No.: US 2025/0156947 A1
(43) Pub. Date: May 15, 2025

(54) ENERGY MANAGEMENT SYSTEM AND ENERGY MANAGEMENT METHOD

(71) Applicant: LITE-ON SINGAPORE PTE. LTD., Singapore (SG)

(72) Inventors: Wei SAI, Singapore (SG); Krishna Kumar GOVINDASAMY, Singapore (SG); Jing YANG, Singapore (SG); Nandha Kumar KANDASAMY, Singapore (SG); Jia Sheng NG, Singapore (SG)

(21) Appl. No.: 18/829,342

(22) Filed: Sep. 10, 2024

(30) Foreign Application Priority Data
Nov. 9, 2023 (SG) 10202303192S

(51) Int. Cl. G06Q 40/04; G06Q 50/06

(52) U.S. Cl. CPC G06Q 40/04; G06Q 50/06

(57) ABSTRACT

An energy management system, for performing a local energy trading with several energy generation units in a local energy field, and performing an energy market trading with an energy market. The energy management system includes a local trading interface, a market trading interface, and a virtual power plant (VPP) platform. The VPP platform is operatively coupled to the local energy field through the local trading interface, and operatively coupled to the energy market through the market trading interface. In the local energy trading, the VPP platform estimates a set of local trading volumes and a set of local trading prices associated with the local energy field. In the energy market trading, the VPP platform provides a set of bids and a set of offerings into the energy market.

This application claims the benefit of Singapore Provisional Application Ser. No. 10/202,303192S filed Nov. 9, 2023, the disclosure of which is incorporated by reference herein in its entirety.

### TECHNICAL FIELD

The present disclosure relates to an energy managing mechanism, and particularly relates to an energy management system and an energy management method applied to a distributed energy system.

### BACKGROUND

Emerging energies have been greatly developed, so as to replace conventional energies and achieve environmental protection. Furthermore, distributed energies, which are provided by a huge amount of distributed energy generating units, are widely employed to replace traditional centralized energy systems.

The distributed energies may encounter difficulties to operate and control since variant renewable energy sources are involved in a distributed system. Furthermore, when energy providers/consumers on local side of the distributed system are greatly grown, energy trading mechanism between the local providers/consumers and the energy market may become complex and hence difficult to handle.

The above mentioned energy trading mechanism may include local energy trading combined with energy market trading (i.e., market participation). Energy supplies and needs must be balanced between the local providers/consumers and the energy market. However, the balancing for energy supplies and needs may be difficult to achieve due to complex behaviors of the providers/consumers and energy market and due to complicated calculations for bidding prices of the energy trading.

In view of the above issues, it's desirable to have an improved energy management system and energy management method, so as to offer optimized strategies for the energy trading, and maximum profits for the local providers/consumers and the energy market may hence be obtained.

### SUMMARY

According to one embodiment of the present disclosure, an energy management system is provided. The energy management system is for performing a local energy trading with a plurality of energy generation units in a local energy field, and performing an energy market trading with an energy market, the energy management system includes a local trading interface, a market trading interface, and a virtual power plant (VPP) platform. The VPP platform is operatively coupled to the local energy field through the local trading interface, and operatively coupled to the energy market through the market trading interface. In the local energy trading the VPP platform estimates a set of local trading volumes and a set of local trading prices associated with the local energy field, in the energy market trading the VPP platform provides a set of bids and a set of offerings into the energy market.

According to another embodiment of the present disclosure, an energy management method is provided. The energy management method performs a local energy trading with a plurality of energy generation units in a local energy field, and performs an energy market trading with an energy market, the management method includes the following steps. Utilizing a virtual power plant (VPP) platform operatively coupled to the local energy field through a local trading interface and operatively coupled to the energy market through a market trading interface. In the local energy trading, the VPP platform is utilized to estimate a set of local trading volumes and a set of local trading prices associated with the local energy field. In the energy market trading, the VPP platform is utilized to provide a set of bids and a set of offerings into the energy market.

### BRIEF DESCRIPTION OF THE DRAWINGS

FIG. 1 is a schematic diagram illustrating an energy management system according to an embodiment of the present disclosure.

FIG. 2 is a block diagram of the VPP platform in the energy management system.

FIGS. 3A to 3C are flow diagrams illustrating operations of the VPP platform utilizing computational models of LETM, EMTM and EMDM.

FIGS. 4A-1 to 4A-6 are schematic diagrams illustrating various value ranges of contract prices.

FIG. 4B is a schematic diagram showing another example of notations for the minimum values and maximum values of the supply contract prices and the demand contract prices.

FIG. 5 is a flow diagram illustrating the utilization of computational model of a market analysis model (MAM) for checking contract prices and determining strategies.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

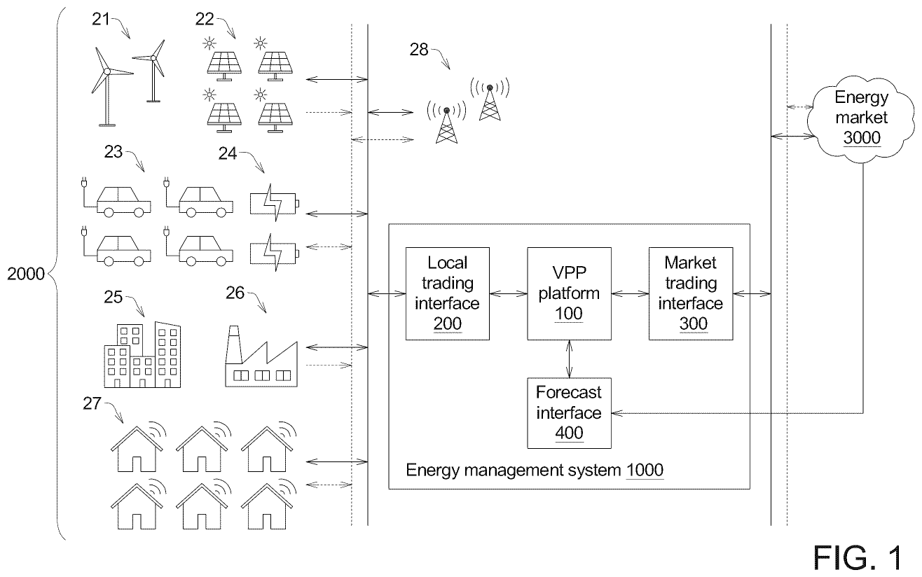

FIG. 1 is a schematic diagram illustrating an energy management system 1000 according to an embodiment of the present disclosure. Referring to FIG. 1, the energy management system 1000 includes a virtual power plant (VPP) platform 100, a local trading interface 200, a market trading interface 300 and a forecast interface 400.

The VPP platform 100 is operatively coupled to a local energy field 2000 through the local trading interface 200. The local energy field 2000 may include various types of energy generation units or energy loads, such as: wind power units 21, solar power units 22, electric vehicles (EVs) 23, battery energy storage system (BESS) 24, commercial buildings 25, industrial buildings 26, smart homes 27, and utility grids 28, etc. Among these energy generation units or energy loads in the local energy field 2000, the wind power units 21 and solar power units 22 are renewable energy resources, which are non-dispatchable generation units. Furthermore, the EVs 23 and BESS 24 are energy storage units. Moreover, the commercial buildings 25 and industrial buildings 26 are dispatchable loads. The VPP platform 100 may perform local energy trading with the above mentioned energy generation units or energy loads in the local energy field 2000.

On the other hand, the VPP platform 100 is operatively coupled to an energy market 3000 through the market trading interface 300. The VPP platform 100 may transfer energy in the local energy field 2000, and energy from the local energy field 2000 may be traded in the energy market 3000.

In addition, the VPP platform 100 may cooperate with the forecast interface 400 to perform predictions and forecasting on market information, e.g., generation forecasting, load forecasting, market price forecasting, and forecasting on latest energy market clearing prices and market signals. The VPP platform 100 together with the forecast interface 400 may hence obtain optimum decisions for the energy market trading with the energy market 3000, such that economic benefits for a user of the energy management system 1000 can be maximized. The above-mentioned of the energy management system 1000 is a “platform user”, e.g., an energy aggregator, an energy retailer, an energy trader, or an independent power producer associated with the energy management system 1000.

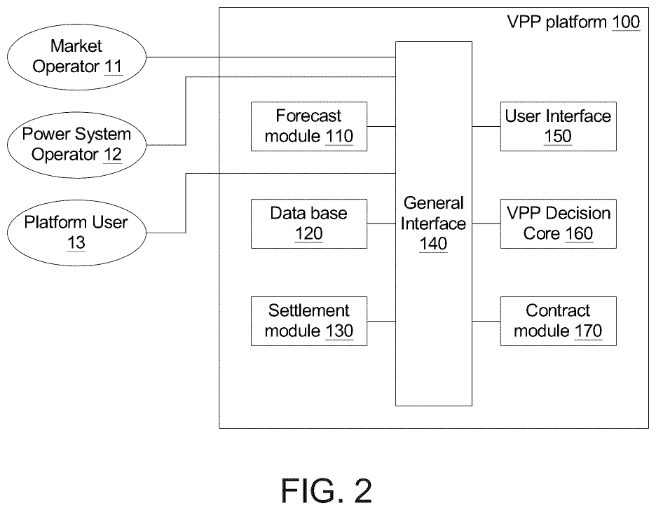

FIG. 2 is a block diagram of the VPP platform 100 in the energy management system 1000. Referring to FIG. 2, the VPP platform 100 may include a forecast module 110, a data base 120, a settlement module 130, a general interface 140, a user interface 150, a VPP decision core 160, and a contract module 170. The forecast module 110 is used to perform forecasting (e.g., generation forecasting, load forecasting, and market price forecasting, etc.) in conjunction with the forecast interface 400 of FIG. 1, so as to generate a set of forecasted data and a set of market data which are mostly updated (i.e., the newest data). The data base 120 is used to store the set of forecasted data (which are generated by the forecast module 110), a set of historian data, and a set of VPP decisions. The settlement module 130 is used to perform settlements for the energy market trading. The user interface 150 is, e.g., a visualized interface (i.e., a GUI) which provides user visualization to facilitate user's control.

The VPP platform 100 may utilize at least three computational models for evaluating the local energy trading and the energy market trading. These computational models are: a local energy trading model (LETM), an energy market trading model (EMTM), and an energy market dispatch model (EMDM). The VPP decision core 160 is used to control the operations of the LETM, the EMTM, or the EMDM, for the platform user 13. Each of the LETM, the EMTM and the EMDM is executed based on at least one objective function and a set of constraints, as will be described in later paragraphs.

The contract module 170 is used to generate a set of smart contracts, and may cooperate with the settlement module 130 to perform auto settlements between a market operator 11 and the platform user 13. The contract module 170 may also update the smart contracts when performing local energy trading and energy market trading. The general interface 140 is used to communicate the market operator 11, the platform user 13 and the power system operator 12 with the internal modules (i.e., the forecast module 110, the data base 120, the settlement module 130, the general interface 140, the user interface 150, the VPP decision core 160, and the contract module 170) of the VPP platform 100, based on a specific communication protocol.

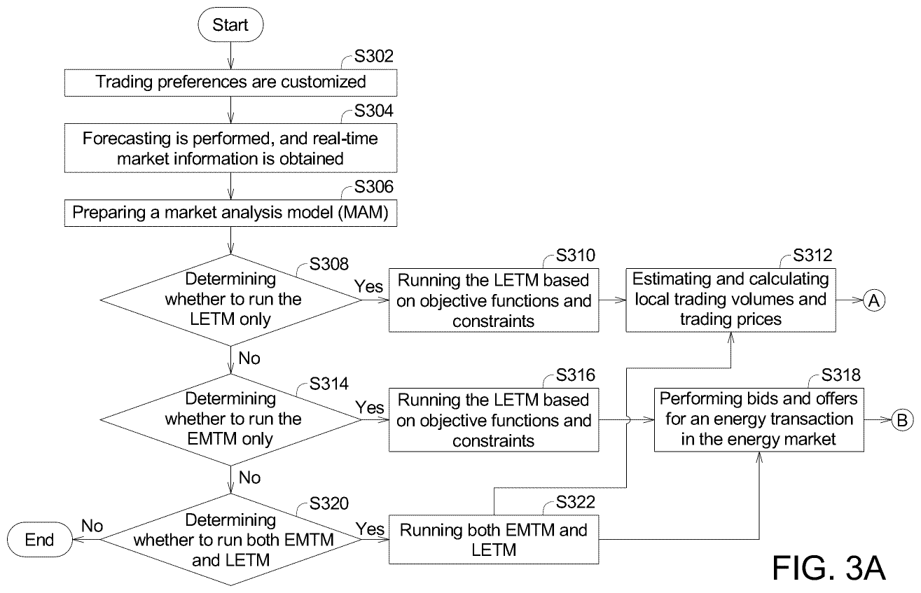

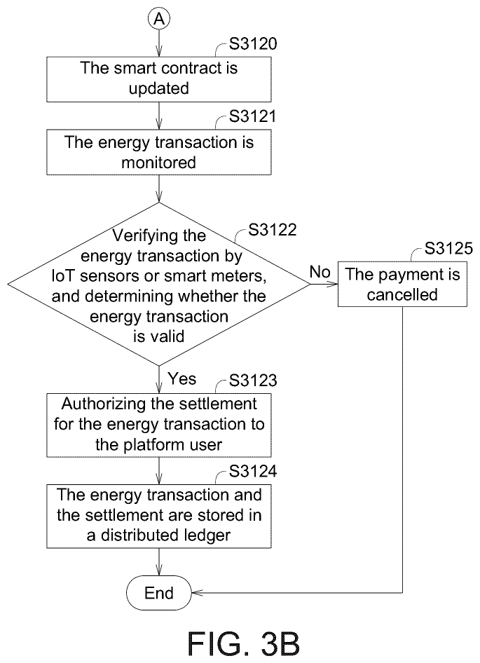

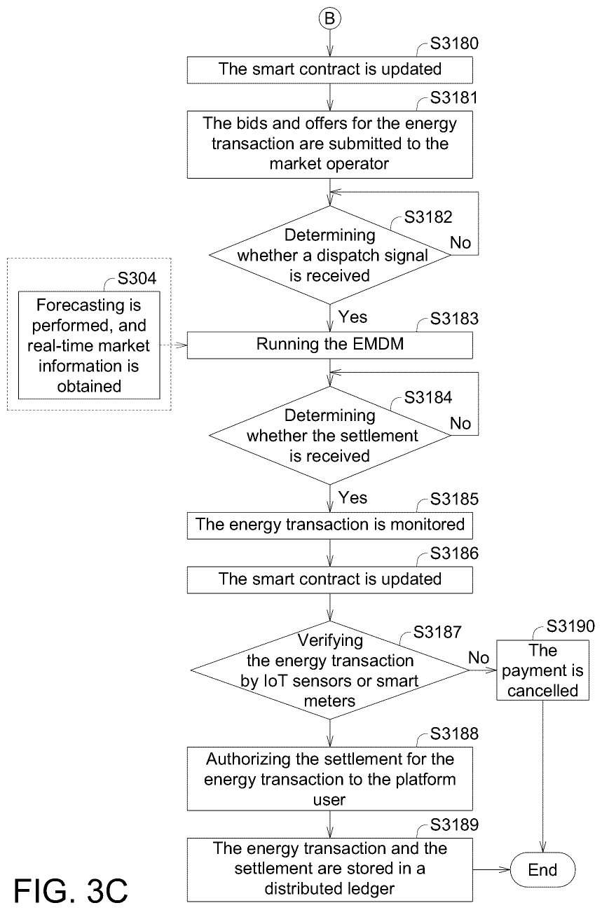

FIGS. 3A to 3C are flow diagrams illustrating operations of the VPP platform 100 utilizing the computational models of LETM, EMTM and EMDM. Firstly, referring to FIG. 3A, step S302 is executed: trading preferences for local energy trading and/or energy market trading are customized. The trading preferences may include: a generation profile, a load profile, a set of technical constraints, and a set of preferences for the smart contracts.

Then, step S304 is executed: forecasting is performed, and real-time market information is obtained. The forecasting includes: forecasting for the generation, forecasting for the load, and forecasting for the market price. Furthermore, the real-time market information may include the latest energy market clearing prices.

Then, step S306 is executed: preparing a market analysis model (MAM), which is used to perform market analysis. Then, step S308 is executed: determining whether to run the LETM (i.e., only the LETM is run). If the result of step S308 is “Yes”, then the flow diagram goes to step S310: running the LETM only, based on objective functions of equations (1-1) and (1-2) and constraints of equations (1-3) to (1-6). Then, step S312 is executed: estimating and calculating local trading volumes and local trading prices. Then, the flow diagram goes to step S3120 of FIG. 3B.

The objective functions and constraints for the LETM are described below. The LETM has a first objective function shown in equation (1-1):

$$maximize {\sum }_{t = 1}^{T} {\sum }_{i = 1}^{N} ( {P}_{it}^{user , buy} {π}_{it}^{contract , buy} Δ t - {P}_{t}^{V P P , b u y} {π}_{t}^{b u y} Δ t ) \qquad ( 1 - 1 )$$

In the objective function of equation (1-1), a product of Pᵢₜ^{user,buy} (i.e., the power of the energy which the platform user 13 buys from VPP platform 100 in a unit time interval), πᵢₜ^{contract,buy} (i.e., a buy-contract-price for platform user 13 to buy energy from VPP platform 100) and unit time interval Δt is obtained. Furthermore, a product of Pₜ^{VPP,buy} (i.e., the power of the energy which the VPP platform 100 buys from the energy market), an offer buy price πₜ^{buy} (i.e., buy price which the VPP platform 100 offers to buy energy from the energy market) and unit time interval Δt is obtained. Then, a difference value between the above two products is obtained, and the objective function refers to maximizing the above-mentioned difference value. This difference value is summed over indexes “i” and “t” (i.e., index “i” indicates the i-th participating user of the VPP platform where i=1, 2, . . . , N, and index “t” indicates the t-th time period where t=1, 2, . . . , T).

More particularly, the objective function(s) of the LETM is/are conditional based on conditions of πₜ^{market} (i.e., a latest energy market clearing price offered in the energy market 3000, or a latest locational marginal price (LMP) for the energy) and πᵢₜ^{contract,sell} (i.e., a sell-contract-price for the platform user 13 to sell the energy to the VPP platform 100). In a first condition, the energy market clearing price πₜ^{market} is less than or equal to a minimum of the sell-contract-price πᵢₜ^{contract,sell} The first condition indicates that, the latest energy market clearing price or LMP πₜ^{market} is less than or equal to the sell-contract-price πᵢₜ^{contract,sell} that the platform user 13 (who has signed with VPP platform) agreed to sell energy to VPP platform. In response to the first condition, the first objective function of equation (1-1) is employed. The first objective function is used to maximize the profits. When the energy market clearing price or the LMP πₜ^{market} is low, it is more profitable for VPP platform 100 to buy from the energy market 3000, and sell energy to the platform user 13 at the buy-contract-price πᵢₜ^{contract,buy} which is the contract price for the platform user 13 to buy energy from VPP platform 100. The sell-contract-price πᵢₜ^{contract,sell} and the buy-contract-price πᵢₜ^{contract,buy} may be included in the smart contracts which are maintained by the contract module 170 of the VPP platform 100.

On the other hand, in a second condition, the energy market clearing price πₜ^{market} is greater than a minimum of the sell-contract-price πᵢₜ^{contract, sell}. The second condition indicates that, the latest energy market clearing price or LMP πₜ^{market} is greater than the sell-contract-price πᵢₜ^{contract,sell} for the platform user 13 to sell energy to VPP platform 100. Then, the LETM employs a second objective function shown in equation (1-2):

$$maximize {\sum }_{t = 1}^{T} {\sum }_{i = 1}^{N} ( {P}_{it}^{user , buy} {π}_{it}^{contract , buy} Δ t + {P}_{t}^{VPP , sell} {π}_{t}^{sell} Δ t - ( {P}_{it}^{LET} + {P}_{t}^{VPP , sell} ) {π}_{it}^{contract , sell} Δ t ) \qquad ( 1 - 2 )$$

In the second objective function as equation (1-2), a product of Pᵢₜ^{user,buy} (i.e., power of the energy which the platform user 13 buys from VPP platform 100 in a unit time interval), the buy-contract-price πᵢₜ^{contract,buy} the unit time interval Δt is obtained. Then, a product of Pₜ^{VPP,sell} (i.e., power of the energy which the VPP platform 100 sells to the energy market 3000), an offer sell price πₜ^{sell} (i.e., sell price which the VPP platform 100 offers to sell energy to the energy market 3000) and unit time interval Δt is obtained. Then, a sum of Pᵢₜ^{LET} (i.e., power of the energy bought from the platform user 13 in local energy trading) and the power of the energy sold to the energy market Pₜ^{VPP,sell} is multiplied by the sell-contract-price πᵢₜ^{contract,sell} to obtain a product, which is then taken to subtract with the sum of a product term “(Pᵢₜ^{user,buy}π^{contract,buy}Δt)” and the product term “(Pᵢₜ^{VPP,sell}πₜ^{sell}Δt) “. The second objective function is used to maximize the above subtracting result. When the LMP is high, it is more profitable for VPP platform 100 to be involved in local energy trading with local energy field 2000, and provide bids and offerings into energy market 3000.

Furthermore, a set of constraints are utilized for the LETM. These constraints are associated with the power of the energy bought from the platform user 13 in local energy trading Pᵢₜ^{LET}, the power of the energy which the platform user 13 buys from VPP platform 100 pᵢₜ^{user,buy} and the power of the energy which the VPP platform 100 sells to the energy market 3000 Pₜ^{VPP,sell}, as shown in equations (1-3) to (1-6):

$${\sum }_{i = 1}^{N} {P}_{it}^{L E T} = {\sum }_{i = 1}^{N} {P}_{it}^{user , buy} , ∀ t ∈ T \qquad ( 1 - 3 )$$

More particularly, equation (1-3) refers to a “power balance constraint”, which ensures that the total local energy trading can satisfy all the local energy demand.

Equation (1-4) refers to a “trading volume constraint”, which ensures that a sum of the power of the energy bought in local energy trading PLET and the power of the energy which the VPP platform 100 sells to the energy market 3000 Pₜ^{VPP,sell} falls within an upper capacity limit Pᵢₜ^{max}, for each platform user 13 and at each time interval Δt.

$${P}_{it}^{L E T} + {P}_{t}^{VPP , sell} \leq {P}_{it}^{max} , ∀ i ∈ N , ∀ t ∈ T \qquad ( 1 - 4 )$$

Equation (1-5) refers to a “local trading volume constraint”, which ensures that the power of the energy bought in local energy trading Pᵢₜ^{LET} can remain within its operational capacity limit, for each platform user 13 during each time interval t. Equation (1-5) includes a lower capacity limit Pᵢₜ^{min} and the upper capacity limit Pᵢₜ^{max}. μᵢₜ is a status of each platform user 13, which indicates whether the user is online or offline. If the i-th user is offline during the time interval t, equation (1-5) is not considered for the i-th user.

$${P}_{it}^{min} {μ}_{it} \leq {P}_{it}^{L E T} \leq {P}_{it}^{max} {μ}_{it} , ∀ i ∈ N , ∀ t ∈ T \qquad ( 1 - 5 )$$

Equation (1-6) refers to a “market selling volume constraint”, which ensures that the power of the energy which the VPP platform 100 sells to the energy market 3000 Pₜ^{VPP,sell} can remain within its operational capacity limit

$${P}_{t}^{min} \leq {P}_{t}^{V P P , s e l l} \leq {P}_{t}^{max} , ∀ t ∈ T \qquad ( 1 - 6 )$$

Referring back to FIG. 3A, if the result of step S308 is “No”, then the flow diagram goes to step S314: determining whether to run the EMTM (i.e., only the EMTM is run). If the result of step S314 is “Yes”, then the flow diagram goes to step S316: running the EMTM only, based on its objective function as equation (2-1) and constraints as equations (2-2) to (2-12). Then, step S318 is executed: performing bids and offers for energy transaction(s) (i.e., energy market trading(s)) in the energy market 3000. Then, the flow diagram goes to step S3180 of FIG. 3C.

The objective functions and constraints for the EMTM are described below. The EMTM has an objective function regarding bids and offers into the energy market 3000, which is shown as equation (2-1):

$$maximize {\sum }_{t = 1}^{T} {\sum }_{i = 1}^{N} ( {P}_{t}^{VPP , sell} {π}_{t}^{sell} Δ t - {P}_{t}^{VPP , buy} {π}_{t}^{buy} Δ t - {P}_{it}^{user , sell} {π}_{it}^{contract , sell} Δ t + {P}_{it}^{user , buy} {π}_{it}^{contract , buy} Δ t β ) \qquad ( 2 - 1 )$$

Equation (2-1) includes: the power of the energy which the VPP πₜ^{sell} platform 100 sells to the energy market 3000 Pₜ^{VPP,sell}, the offer sell price πₜ^{sell} (i.e., sell price which the VPP platform 100 offers to sell energy to the energy market 3000), the power of the energy which the VPP platform 100 buys from the energy market Pₜ^{VPP,buy}, the offer buy price πₜ^{buy} (i.e., buy price which the VPP platform 100 offers to buy energy from the energy market), the power of the energy which the platform user 13 sells to the VPP platform 100 Pᵢₜ^{user,sell}, the sell-contract-price for platform user 13 to sell energy to the VPP platform 100 πᵢₜ^{contract,sell}, the power of the energy which the platform user 13 buys from VPP platform 100 Pᵢₜ^{user,buy} the buy-contract-price for platform user 13, to buy energy from VPP platform 100 Tᵢₜ^{contract,buy}. Furthermore, the definition of index “β” for EMTM refers to a “premium charge” for a buying power for the platform user 13 (who has signed a buying contract with VPP platform 100). The objective function as equation (2-1) is used to maximize a profit when VPP platform 100 bids into the energy market 3000, by means of aggregating the buy energy and the sell energy needed from the platform user 13.

Moreover, the EMTM has constraints shown in equations (2-2) to (2-12):

$${\sum }_{i = 1}^{N} {P}_{it}^{user , sell} - {\sum }_{i = 1}^{N} {P}_{it}^{user , buy} = {P}_{t}^{VPP , sell} - {P}_{t}^{VPP , buy} \qquad ( 2 - 2 )$$

In equation (2-2), this constraint refers to a “power balance constraint”. Σᵢ₌₁^{N}P^{user,sell} is the total power of energy which the platform users 13 sell to the VPP platform 100. Σᵢ₌₁^{N}P^{user,buy} is the total power of energy which the platform users 13 buy from the VPP platform 100. The difference between Σᵢ₌₁^{N}P^{user,sell} and Σᵢ₌₁^{N}P^{user,buy} must be equal to the difference between Pₜ^{VPP,sell} (power sold to the energy market 3000 by the VPP platform 100) and Pₜ^{VPP,buy} (power bought from the energy market 3000 by the VPP platform 100).

Equation (2-3) also refers to the “power balance constraint”, which ensures that Σᵢ₌₁^{N}P^{user,buy} must be equal to the Σᵢ₌₁^{N}P^{user,sell} at the time interval t.

$${\sum }_{i = 1}^{N} {P}_{it}^{user , buy} = {P}_{t}^{VPP , buy} \qquad ( 2 - 3 )$$

Equations (2-4) and (2-5) refer to “platform user sell/buy constraints”, which ensures that the power sell/buy volume required by each platform user 13 over each time interval can fall within a minimum and a maximum of power limits allowed for that platform user 13.

$${P}_{it}^{user , sell , min} {μ}_{it} \leq {P}_{it}^{user , sell} \leq {P}_{it}^{user , sell , max} {μ}_{it} \qquad ( 2 - 4 )$$

$${P}_{it}^{u s e r , b u y , m i n} {μ}_{it} \leq {P}_{it}^{user , buy} ( t ) \leq {P}_{it}^{user , buy , max} {μ}_{it} \qquad ( 2 - 5 )$$

Equations (2-6) and (2-7) refer to “VPP platform sell/buy constraints”, which ensure that the power sell/buy volume offered by VPP platform 100 offering to the energy market 3000, over each time interval, can fall within a minimum and a maximum of power limits allowed for VPP platform 100.

$${P}_{it}^{VPP , sell , min} \leq {P}_{it}^{VPP , sell} \leq {P}_{it}^{VPP , sell , max} \qquad ( 2 - 6 )$$

$${P}_{it}^{V P P , buy , min} \leq {P}_{it}^{V P P , b u y} \leq {P}_{it}^{V P P , buy , max} \qquad ( 2 - 7 )$$

Equation (2-8) refers to a “profit constraint”, which ensures that the selling income of VPP platform 100 is always greater than or equal to the contractual selling income between the VPP platform 100 and the platform user 13. The profits of the VPP platform 100 will be within a “contractual margin”.

$${P}_{it}^{u , sell} {π}_{it}^{contract , sell} \leq {P}_{t}^{VPP , sell} {π}_{t}^{s e l} \qquad ( 2 - 8 )$$

Equations (2-9) and (2-10) refer to “sell/buy price constraints” for VPP platform 100, which apply dynamics multipliers ωₜ^{min}, ωₜ^{max}, γₜ^{min} and γₜ^{max} on the forecasted energy market clearing price πₜ^{forecast} (or also referred to as the forecasted locational marginal price). Therefore, the offer sell price πₜ^{sell} and the offer buy price πₜ^{buy} can be cleared with a higher probability.

$${ω}_{t}^{min} {π}_{t}^{forecast} \leq {π}_{t}^{s e l l} \leq {ω}_{t}^{max} {π}_{t}^{forecast} \qquad ( 2 - 9 )$$

$${γ}_{t}^{min} {π}_{t}^{forecast} \leq {π}_{t}^{b u y} \leq {γ}_{t}^{max} {π}_{t}^{forecast} \qquad ( 2 - 10 )$$

Equations (2-11) and (2-12) refer to “dynamics multipliers constraints”.

$$0 \leq {ω}_{t}^{min} \leq {ω}_{t}^{max} \leq 1 \qquad ( 2 - 11 )$$

$$0 \leq {γ}_{t}^{min} \leq {γ}_{t}^{max} \leq 1 \qquad ( 2 - 12 )$$

Equations (2-11) and (2-12) ensure the following conditions:

Condition (A): several multipliers of ωₜ^{min}, ωₜ^{max}, γₜ^{min}, γₜ^{max} have values between 0 and 1, which are dynamic and adjusted based on a “Price-Taker Strategy”.

Condition (B): taking VPP platform 100 as a market participant who has no power to set the energy price, but must accept the energy market clearing price πₜ^{market} determined by the supply and demand in the energy market 3000.

Condition (C): the bid/offer prices submitted by VPP platform 100 to the energy market 3000 are always lower than the forecasted energy market clearing price πₜ^{forecast} (assuming that the forecasted energy market clearing price πₜ^{forecast} is highly trustworthy).

Referring back to FIG. 3A, if the result of step S314 is “No”, then the flow diagram goes to step S320: determining whether to run both the EMTM and the LETM. If the result of step S320 is “Yes”, then the flow diagram goes to step S322: running both the EMTM and the LETM. Then, both steps S318 and S312 are executed. Then, the flow diagram goes to step S3120 of FIG. 3B and step S3180 of FIG. 3C respectively.

Referring to FIG. 3B, from step S3120 to step 3124, energy transaction(s) (i.e., including energy trading and/or settlement(s)) utilizing the LETM, are monitored. More particularly, firstly, step S3120 is executed: the smart contracts are updated. Then, step S3121 is executed: energy transaction(s) is/are monitored. Then, step S3122 is executed: verifying the energy transaction(s) by a plurality of detecting devices (e.g., Internet of Things (IoT) sensors or smart meters), and determining whether the energy transaction(s) is/are valid.

If the result of step S3122 is “Yes”, then the flow diagram goes to step S3123: authorizing the settlement(s) for the energy transaction(s) to the platform user 13. Then, step S3124 is executed: the energy transaction(s) and the settlement(s) are stored in a recording file (e.g., a distributed ledger) in the data base 120. On the other hand, if the result of step S3122 is “No”, then the flow diagram goes to step S3125: payment(s) for the energy transaction(s) is/are cancelled.

Referring to FIG. 3C, step S3180 is executed: the smart contracts are updated. Then, step S3181 is executed: the bids and offers for the energy transaction(s) are submitted to the market operator 11. Then, step S3182 is executed: determining whether a dispatch signal is received by the VPP platform 100. If the result of step S3182 is “No”, then step S3182 is repeated. On the other hand, if the result of step S3182 is “Yes”, then the flow diagram goes to step S3183: running the EMDM, for dispatching to a plurality of platform users 13. The EMDM is executed based on an objective function as equations (3-1) and a set of constraints as equations (3-2) to (3-5):

$$maximize {\sum }_{t = 1}^{T} {\sum }_{i = 1}^{N} [ ( {P}_{t}^{m a rket} {π}_{t}^{m a rket} ) Δ t - α ( {P}_{it}^{u s e r , dispatch} {π}_{it}^{contract , sell} ) Δ t - α ( {P}_{it}^{user , dispatch} {β}_{t} ( 1 - {RI}_{t} ) ) Δ t ] \qquad ( 3 - 1 )$$

The objective function shown in equation (3-1) for the EMDM refers to: the VPP platform 1000 dispatches energy to each of the platform users 13, based on a hybrid mode with a combination of “cost-based dispatch” and “performance-based dispatch”.

More particularly, α is a weight value for weighting the cost-based dispatch and performance-based dispatch respectively. When α is equal to “1”, cost-based dispatch is utilized. When α is equal to “0”, performance-based dispatch is utilized. When α is between “0” and “1”, a hybrid of cost-based dispatch and performance-based dispatch are utilized.

Equation (3-1) includes the energy market clearing price πₜ^{market} and the energy market cleared power volume Pₜ^{market}, which are dispatched to VPP platform 100. The item Pₜ^{user,dispatch} is defined as “dispatched power” from VPP platform 100 to each platform user 13.

Moreover, the coefficient βₜ is the dynamic penalty cost due to a low performance of one platform user 13. The index RIₜ is the dynamic performance index of all of platform users 13. For example, the dynamic performance index RIₜ may be evaluated based on a performance standard of the Pennsylvania-New Jersey-Maryland Interconnection (PJM).

The objective function of EMDM in equation (3-1) is used to maximize profits of VPP platform 100 by means of dispatching the energy market cleared power volume Pₜ^{market} to each platform user 13, so as to maximize the total profits of VPP platform 100 over the total revenue earned from the energy market 3000, with the total cost by paying the platform user 13 for supplying power. Total penalty term on dispatching to a specific one of platform users 13 is based on its ability to meet its performance indicator (i.e., still meeting the market dispatch amount at the buy-contract-price πᵢₜ^{contract,buy} or the sell-contract-price πᵢₜ^{contract,sell}).

In addition, the EMDM is executed with constraints as equations (3-2) to (3-5). Equation (3-2) is a “power balance constraint” ensuring that the total power dispatched to the platform users 13, at each time interval, is equal to the energy market cleared power volume Pₜ^{market}.

$${P}_{t}^{m a rket} = {\sum }_{i = 1}^{N} {P}_{it}^{user , dispatch} , ∀ t ∈ T \qquad ( 3 - 2 )$$

Equation (3-3) is a “power output constraint” for platform users 13, which ensures that power generation output of each platform user 13 falls within a minimum power output capacity limit Pᵢₜ^{user,min} and a maximum power output capacity limit Pᵢₜ^{user, max}.

$${P}_{it}^{user , min} {μ}_{it} \leq {P}_{it}^{user , dispatch} \leq {P}_{it}^{user , max} {μ}_{it} , ∀ i ∈ N , ∀ t ∈ T \qquad ( 3 - 3 )$$

Equation (3-4) is a “weight value constraint”, with value of a between 0 and 1. This constraint selects the weight value for the cost-based dispatch mode and the performance-based dispatch mode of the EMDM.

$$0 \leq α \leq 1 \qquad ( 3 - 4 )$$

Equation (3-5) is a “performance index constraint”, with value of RIₜ between 0 and 1.

$$0 \leq {RI}_{t} \leq 1 \qquad ( 3 - 5 )$$

Equation (3-5) ensures performance of VPP platform 100 for platform users 13, based on the three factors (F1) to (F3), as follows:

The first factor (F1): “accuracy”, is evaluated by a correlation or degree of relationship between controls. The “accuracy” is defined as an average of correlation scores for a given time interval. The correlation scores are defined as γδ (Signal, Response). The index “δ” may range from 1 minute to a specific time interval. The index “γ” is a statistical correlation function.

The second factor (F2): “delay”, refers to a time delay between a control signal and a point of highest correlation. The VPP platform 100 participates in the energy market 3000, and the platform user(s) 13 is/are quantified based on a control signal issued by VPP platform 100 and sent to the platform user(s) 13. The “delay score” may be measured at the point of highest correlation at a 30-minute interval.

The third factor (F3): “precision”, is evaluated by an instantaneous error between the control signal and a response from a regulating unit. The instantaneous error “¿” may be evaluated by equation (3-6):

$$ε = average of absolute \vert \frac{Actual Output - Desired Output}{H ourly Average Desired Output} \vert \qquad ( 3 - 6 )$$

These factors (F1) to (F3) may be defined and evaluated based on the PJM market standard, for evaluating the market participants providing a frequency regulation service. The value of “RIₜ” may be adjusted by these factors (F1) to (F3), as equation (3-7):

$${RI}_{t} = ( \frac{1}{3} \times Accuracy ) + ( \frac{1}{3} \times Delay ) + ( \frac{1}{3} \times Precision ) \qquad ( 3 - 7 )$$

Referring back to FIG. 3C, in another example, step S3183 may be performed after step S304 of FIG. 3A (in step S304 of FIG. 3A, forecasting is performed, and real-time market information is obtained). Then, step S3184 is determining whether the settlement(s) with the energy market 3000 is/are received. If the result of step S3184 is “No”, then step S3184 is repeated. On the other hand, if the result of step S3184 is “Yes”, then the flow diagram goes to step S3185: the energy transaction(s) is/are monitored. Then, step S3186 is executed: the smart contracts are updated, again. Then, step S3187 is executed: verifying the energy transaction(s) by the detecting devices, and determining whether the energy transaction(s) is/are valid.

If the result of step S3187 is “No”, then the flow diagram goes to step S3190: the payment(s) for the energy transaction(s) is/are cancelled. On the other hand, if the result of step S3187 is “Yes”, then the flow diagram goes to step S3188: authorizing the settlement(s) for the energy transaction(s) to the platform user 13. Then, step S3189 is executed: the energy transaction(s) and the settlement(s) are stored in the distributed ledger of the data base 120.

FIGS. 4A-1 to 4A-6 are schematic diagrams illustrating various value ranges of contract prices. The contract prices include the sell-contract-price πᵢₜ^{contract,sell} for the platform user 13 to sell energy to the VPP platform 100 and the buy-contract-price πᵢₜ^{contract,buy} for the platform user 13 to buy energy from the VPP platform 100. FIGS. 4A-1 to 4A-6 show six cases (i.e., case (1) to case (6)) indicating various relationships of value ranges of the sell-contract-price πᵢₜ^{contract,sell} and the buy-contract-price πᵢₜ^{contract,buy} The sell-contract-price πᵢₜ^{contract,sell} may have a value range marked as label “A”, and the buy-contract-price πᵢₜ^{contract,buy} may have a value range marked as label “B”.

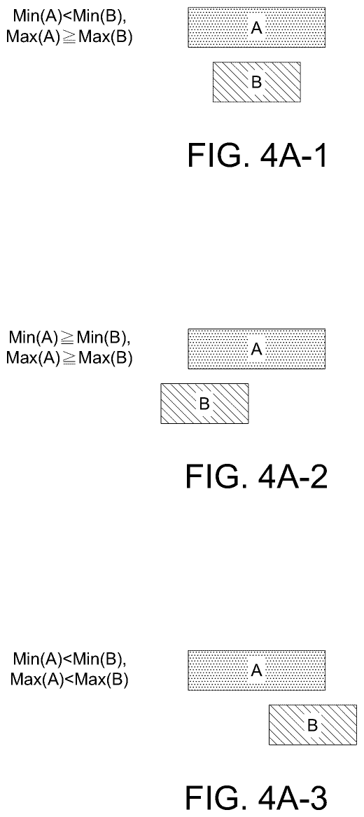

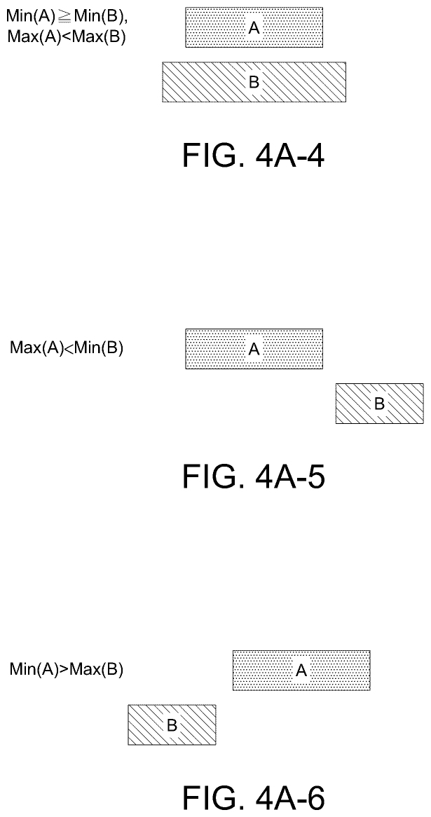

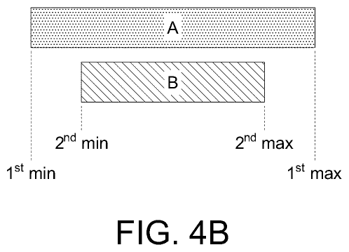

As shown in FIG. 4A-1, the sell-contract-price πᵢₜ^{contract,sell} has a minimum value “Min (A)” and a maximum value “Max (A)”. Likewise, buy-contract-price πᵢₜ^{contract,buy} has a minimum value “Min (B)” and a maximum value “Max (B)”. FIG. 4A-1 is case (1) where Min (A) is less than Min (B), and Max (A) is greater than or equal to Max (B). In case (1), it is profitable to perform local energy trading with local energy field 2000. Therefore, the VPP decision core 160 may provide a strategy to suggest to the platform user 13 to sell energy to the VPP platform 100. When the energy market clearing price πₜ^{market} is greater than or equal to the maximum value Max (A), actions of local energy trading and selling are suggested to the platform user 13. Remaining power and capacity may be offered in the energy market 3000 for sale.

Referring to FIG. 4A-2, in case (2), Min (A) is greater than or equal to Min (B), and Max (A) is greater than or equal to Max (B). In case (2), it is profitable to perform local energy trading with local energy field 2000. VPP decision core 160 may provide a strategy to suggest to the platform user 13 to buy energy from the VPP platform 100. When the energy market clearing price πₜ^{market} is less than or equal to Min (A), actions of local energy trading and buying are suggested. The VPP decision core 160 may check if energy generation of the local energy field 2000 is curtailable. If this energy generation is curtailable, then this energy generation is stopped, and energy is bought from the energy market 3000 in bulk so as to cover the demand of the plurality of platform users 13. Otherwise (i.e., this energy generation is not curtailable), local energy balancing will be proceeded, and energy is bought (with residual volume) from the energy market 3000 to cover the demand.

Referring to FIG. 4A-3, in case (3), Min (A) is less than Min (B), and Max (A) is less than Max (B). In case (3), VPP decision core 160 may provide a strategy to suggest the platform user 13 to buy (and/or sell) energy from (and/or to) the VPP platform 100 depending on respective weight values. When the energy market clearing price πₜ^{market} is between Min (A) and Min (B), the platform user 13 may be suggested to buy (and/or sell) as equation (4-1):

$$( w 1 \times LET ) + ( w 2 \times SELL ) + ( w 3 \times BUY ) \qquad ( 4 - 1 )$$

In equation (4-1), the action of local energy trading (i.e., “LET”), the action of buying (i.e., “BUY”) and the action of selling (i.e., “SELL”) may be respectively weighted by weight values w1, w2 and w3.

Referring to FIG. 4A-4, in case (4), Min (A) is greater than or equal to Min (B), and Max (A) is less than Max (B). In case (4), it is profitable to perform the local energy trading with local energy field 2000, and VPP decision core 160 may provide a strategy to suggest to the platform user 13 to buy (and/or sell) energy from (and/or to) the VPP platform 100 depending on respective weight values as equation (4-1). When the energy market clearing price πₜ^{market} is between Min (B) and Max (B), the platform user 13 is suggested to offer bids and buy energy from the energy market 3000.

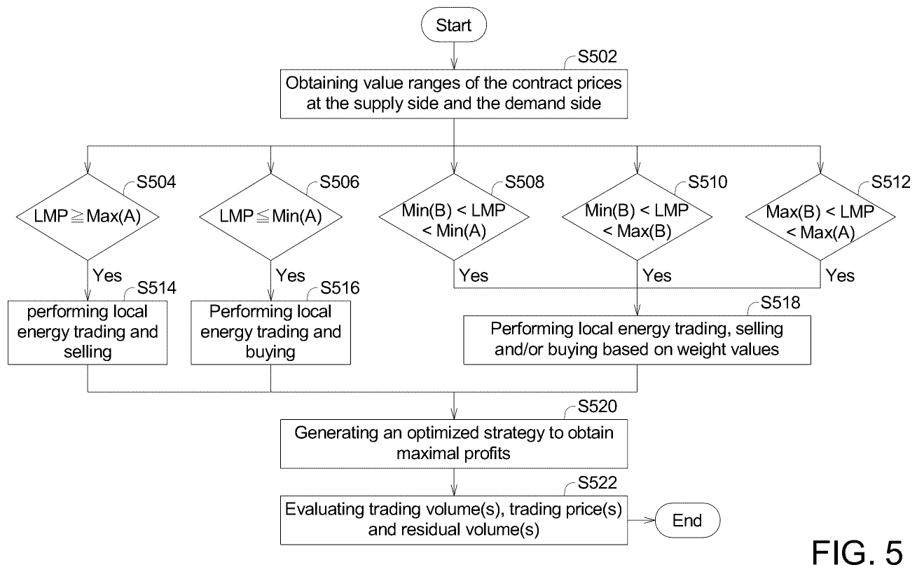

Referring to FIG. 4A-5, in case (5), Max (A) is less than Min (B). In case (5), it is profitable to perform local energy trading with local energy field 2000, and VPP decision core 160 may provide a strategy to suggest to the platform user 13 to buy (and/or sell) energy from (and/or to) the VPP platform 100 depending on respective weight values as equation (4-1). When the energy market clearing price πₜ^{market} is between Max (A) and Max (B), the VPP decision core 160 may check whether the energy market clearing price πₜ^{market} can cover the cost of generation for the remaining capacity. If the energy market clearing price πₜ^{market} can cover the cost of generation, then the VPP platform 100 offers the remaining energy to be sold in the energy market 3000. Otherwise, energy is not offered for sale in the energy market 3000.

Referring to FIG. 4A-6, in case (6), Min (A) is greater than Max (B). In case (6), it is not profitable to perform local energy trading with local energy field 2000. Therefore, the VPP decision core 160 may provide a strategy to suggest: not to perform local energy trading and the energy market trading. Consequently, payment(s) for the energy transaction(s) will be cancelled (as step S3125 in FIG. 3B and step S3190 in FIG. 3C).

Referring to FIG. 4B, it shows another example of notations for the πᵢₜ^{contract,sell} minimum values and maximum values of the sell-contract-price πᵢₜ^{contract,sell} and the buy-contract-price πᵢₜ^{contract,buy} The minimum value “Min (A)” and maximum value “Max (A)” of the sell-contract-price πᵢₜ^{contract,sell} in FIGS. 4A-1 to 4A-6 may be alternatively labeled as “1^{st} min” and “1^{st} max” respectively. Likewise, the minimum value “Min (B)” and maximum value “Max (B)” of the buy-contract-price πᵢₜ^{contract,buy} in FIGS. 4A-1 to 4A-6 may be alternatively labeled as “2^{nd} min” and “2^{nd} max” respectively.

FIG. 5 is a flow diagram illustrating the utilization of a computational model of a market analysis model (MAM) for checking contract prices and determining strategies. Firstly, step S502 is executed: obtaining value ranges of the sell-contract-price πᵢₜ^{contract,sell} and the buy-contract-price πᵢₜ^{contract,buy} and locating their maximum values Max (A) and Max (B) and minimum values Min (A) and Min (B).

Then, step S504 is executed: determining whether the energy market clearing price or locational marginal price (LMP) πₜ^{market} is greater than or equal to Max (A). If the result of step S504 is “Yes”, it is profitable for the platform user 13 to sell energy, then the flow diagram goes to step S514: the VPP decision core 160 provides a strategy to suggest to the platform user 13 to perform local energy trading and sell energy to the energy market 3000.

Step S506 may be executed concurrently with step S504. In step S506, it is determined whether the LMP πₜ^{market} is less than or equal to Min (A). If the result of step S506 is “Yes”, it is profitable for the platform user 13 to buy energy, then the flow diagram goes to step S516: the VPP decision core 160 provides a strategy to suggest to the platform user 13 to perform local energy trading and buy energy from the energy market 3000.

Step S508 may be executed concurrently with steps S504 and S506. In step S508, it is determined whether the LMP πₜ^{market} is between Min (A) and Min (B). If the result of step S508 is “Yes”, then step S518 is executed: the VPP decision core 160 provides a strategy to suggest to the platform user 13 to perform local energy trading, selling and/or buying based on their respective weight values.

Likewise, step S510 and step S512 may be executed concurrently with steps S504, S506 and S508. In step S510, it is determined whether the LMP market πₜ^{market} is between Min (B) and Max (B). Furthermore, in step S512, it is determined whether the LMP πₜ^{market} is between Max (A) and Max (B). If either of the results of steps S510 and S512 is “Yes”, the flow diagram will go to step S518: the VPP decision core 160 provides a strategy to suggest to the platform user 13 to perform local energy trading, selling and/or buying based on their respective weight values.

Then, step S520 is executed subsequently to steps S514, S516 and S518. In step S520, the VPP decision core 160 may be utilized to generate an optimized strategy or optimized decision to achieve maximum profits in the local energy trading and/or the energy market trading. This optimized strategy may accomplish matched balancing between the platform users 13 and the energy market 3000.

Then, step S522 is executed: trading volumes and trading prices (the sell-contract-price Tᵢₜ^{contract,sell}, the buy-contract-price Tᵢₜ^{contract,buy} and the energy market clearing price πₜ^{market}) are evaluated for matched balancing. The trading volume(s) may be power volumes of energy bought and/or sold in the energy market trading. Furthermore, residual volume(s), which are associated with the bids to buy or the offers to sell, are evaluated.

In view of the above various embodiments, the energy management system 1000 of the present disclosure may provide local energy trading in combination with market participation (i.e., energy market trading) to maximize the profits of the platform users 13. Furthermore, the energy management system 1000 may provide auto settlements among platform operator and platform user of the VPP platform 100, utilizing block-chain and smart contracts. Auto-bidding and participation in both Day-Ahead Market (DAM) and Real-Time Market (RTM) may be provided for energy trading, so as to achieve grid ancillary services and demand response. Moreover, the energy management system 1000 may provide advanced bidding and dispatching strategies based on latest forecast and market information. In addition, balancing-out fluctuations in renewable power generation may be achieved. Also, power balancing and energy self-sufficiency may be facilitated.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. An energy management system, for performing a local energy trading with a plurality of energy generation units in a local energy field, and performing an energy market trading with an energy market, the energy management system comprising:
a local trading interface;
a market trading interface; and
a virtual power plant (VPP) platform, operatively coupled to the local energy field through the local trading interface, and operatively coupled to the energy market through the market trading interface,
wherein, in the local energy trading, the VPP platform estimates a set of local trading volumes and a set of local trading prices associated with the local energy field, in the energy market trading, the VPP platform provides a set of bids and a set of offerings into the energy market.

2. The energy management system of claim 1, wherein the VPP platform utilizes a local energy trading model (LETM) to evaluate the local energy trading, and utilizes an energy market trading model (EMTM) to evaluate the energy market trading.

3. The energy management system of claim 2, wherein the VPP platform comprises:
a VPP decision core, for operating the LETM with a first objective function or a second objective function conditionally based on a relationship between an energy market clearing price and a sell-contract-price for selling energy to the VPP platform.

4. The energy management system of claim 3, wherein the first objective function is related to a power of energy bought from the VPP platform and a power of energy bought from the energy market, and the second objective function is related to the power of energy bought from the VPP platform and a power of energy sold to the energy market.

5. The energy management system of claim 3, wherein the VPP decision core further operates the EMTM with a third objective function, and the third objective function is related to a power of energy bought from the VPP platform, a power of energy bought from the energy market, a power of energy sold to the VPP platform, and a power of energy sold to the energy market.

6. The energy management system of claim 3, wherein the VPP decision core conditionally operates an energy market dispatch model (EMDM) for the VPP platform to dispatch energies to a plurality of platform users in response to a dispatch signal.

7. The energy management system of claim 6, wherein the EMDM is operated with a combination of cost-based dispatch and performance-based dispatch.

8. The energy management system of claim 6, wherein the EMDM is operated with a fourth objective function, and the fourth objective function is related to the energy market clearing price dispatched to VPP platform, an energy market cleared power volume dispatched to VPP platform, and a dispatched power from the VPP platform to each of the platform users.

9. The energy management system of claim 3, wherein the VPP decision core further operates a market analysis model (MAM) to locate a first maximum value and a first minimum value of the sell-contract-price and a second maximum value and a second minimum value of a buy-contract-price for buying energy from the VPP platform.

10. The energy management system of claim 9, wherein when the energy market clearing price is greater than or equal to the first maximum value, the VPP decision core provides a strategy to perform the local energy trading and selling energy to the energy market.

11. An energy management method, for performing a local energy trading with a plurality of energy generation units in a local energy field, and performing an energy market trading with an energy market, the management method comprising:
utilizing a virtual power plant (VPP) platform operatively coupled to the local energy field through a local trading interface and operatively coupled to the energy market through a market trading interface;
in the local energy trading, utilizing the VPP platform to estimate a set of local trading volumes and a set of local trading prices associated with the local energy field; and
in the energy market trading, utilizing the VPP platform to provide a set of bids and a set of offerings into the energy market.

12. The energy management method of claim 11, wherein the VPP platform utilizes a local energy trading model (LETM) to evaluate the local energy trading, and utilizes an energy market trading model (EMTM) to evaluate the energy market trading.

13. The energy management method of claim 12, wherein the step of utilizing the LETM to evaluate the local energy trading comprising:
utilizing a VPP decision core of the VPP platform to operate the LETM with a first objective function or a second objective function conditionally based on a relationship between an energy market clearing price and a sell-contract-price for selling energy to the VPP platform.

14. The energy management method of claim 13, wherein the first objective function is related to a power of energy bought from the VPP platform and a power of energy bought from the energy market, and the second objective function is related to the power of energy bought from the VPP platform and a power of energy sold to the energy market.

15. The energy management method of claim 13, wherein the step of utilizing the EMTM to evaluate the energy market trading comprising:
utilizing the VPP decision core to operate the EMTM with a third objective function,
wherein the third objective function is related to a power of energy bought from the VPP platform, a power of energy bought from the energy market, a power of energy sold to the VPP platform, and a power of energy sold to the energy market.

16. The energy management method of claim 13, further comprising:
utilizing the VPP decision core to conditionally operate an energy market dispatch model (EMDM),
wherein the EMDM is utilized for the VPP platform to dispatch energies to a plurality of platform users in response to a dispatch signal.

17. The energy management method of claim 16, wherein the EMDM is operated with a combination of cost-based dispatch and performance-based dispatch.

18. The energy management method of claim 16, wherein the EMDM is operated with a fourth objective function, and the fourth objective function is related to the energy market clearing price dispatched to VPP platform, an energy market cleared power volume dispatched to VPP platform, and a dispatched power from the VPP platform to each of the platform users.

19. The energy management method of claim 13, further comprising:
utilizing the VPP decision core to operate a market analysis model (MAM) to locate a first maximum value and a first minimum value of the sell-contract-price and a second maximum value and a second minimum value of a buy-contract-price for buying energy from the VPP platform.

20. The energy management method of claim 19, wherein when the energy market clearing price is greater than or equal to the first maximum value, the energy management method further comprising:
utilizing the VPP decision core to provide a strategy to perform the local energy trading and selling energy to the energy market.
